(19) United States
(12) Patent Application Publication
(10) Pub. No.: US 2019/0149624 A1
(43) Pub. Date: May 16, 2019

(54) LOW POWER WIDE AREA NETWORK SYSTEM

(71) Applicant: Institute For Information Industry, Taipei (TW)

(72) Inventors: Shu-Han Liao, New Taipei City (TW); Shu-Tsz Liu, Taipei City (TW); Hong-Hai Hsu, New Taipei City (TW); Yi-Hsueh Tsai, New Taipei City (TW)

(21) Appl. No.: 15/832,726

(22) Filed: Dec. 5, 2017

(30) Foreign Application Priority Data
Nov. 16, 2017 (TW) 106139720

(51) Int. Cl. H04L 29/08; H04L 29/06

(52) U.S. Cl. CPC H04L 67/18; H04L 67/12; H04L 65/1063

(57) ABSTRACT

An LPWAN system and positioning method thereof are provided. An LPWAN system includes an application server and an end device. The application server receives a positioning request from the end device and transmits a positioning initial information to a plurality of network devices. Signal measurements are made between the end device and the network devices for deciding a plurality of path loss information. The application server determines an end position of the end device according to the path loss information and a plurality of network positions of the network devices.

### PRIORITY

This application claims priority to Taiwan Patent Application No. 106139720 filed on Nov. 16, 2017, which is hereby incorporated by reference in its entirety.

### FIELD

The present invention relates to a wide area network system and a positioning method thereof. More particularly, the present invention relates to a Low Power Wide Area Network (LPWAN) system and a positioning method thereof.

### BACKGROUND

Internet of Things (IoT) communication is a network technology currently being developed vigorously. Through such a technology, different devices can be connected together via network so that the devices communicate and exchange data with each other. Generally speaking, the network environment of the IoT was mainly limited to a particular range in the past, so the communication technology of a short distance can satisfy requirements thereof.

However, as the IoT finds wider applications gradually, the communication technology of a short distance is insufficient to satisfy requirements thereof, so an IoT communication technology of a long distance and a large range is developed. A Low Power Wide Area Network (LPWAN) technology is the mainstream of current IoT long-distance communication.

However, in the LPWAN technology, although various communication protocols are being developed, no standard is available in the communication protocols for the device positioning technology, and the device positioning technology is usually accomplished based on time reference of message transmission. Thus, there is a problem of a low positioning accuracy. On the other hand, the positioning accuracy may also be enhanced by using the communication protocol and GPS hardware in combination. However, this generates excessively large power consumption and it is hard to satisfy the low-power requirement of the LPWAN.

Accordingly, an urgent need exists in the art to improve drawbacks in positioning of the communication protocols in the conventional LPWAN.

### SUMMARY

The disclosure includes an LPWAN system, which comprises an application server and an end device. The application server: receives a positioning request from the end device; and transmits a positioning initial information to the end device and at least one network device according to the positioning request so that the at least one network device transmits at least one network message according to the positioning initial information. The end device: receives the at least one network message according to the positioning initial information; determines at least one path loss information between the end device and the at least one network device according to the at least one network message; transmits the at least one path loss information to the application server. The application server further: decides an end position of the end device according to at least one position of the at least one network device and the at least one path loss information.

The disclosure also includes a positioning method for use in a Low Power Wide Area Network (LPWAN) system. The LPWAN system comprises an application server and an end device. The positioning method comprises: receiving, by the application server, a positioning request from the end device; transmitting, by the application server, a positioning initial information to the end device, a first network device, a second network device and a third network device according to the positioning request so that the first network device, the second network device and the third network device transmit a first network message, a second network message and a third network message respectively according to the positioning initial information; and receiving, by the end device, the first network message, the second network message and the third network message according to the positioning initial information.

Next, the positioning method further comprises: determining, by the end device, first path loss information, second path loss information and third path loss information between the end device and the first network device, the second network device and the third network device respectively according to the first network message, the second network message and the third network message; transmitting, by the end device, the first path loss information, the second path loss information and the third path loss information to the application server; and deciding, by the application server, an end position of the end device according to a first position of the first network device, a second position of the second network device, a third position of the third network device, the first path loss information, the second path loss information and the third path loss information.

The disclosure further includes a positioning method for use in an LPWAN system. The LPWAN system comprises an application server and an end device. The positioning method comprises: receiving, by the application server, a positioning request from the end device; transmitting, by the application server, a positioning initial information to the end device, a first network device a second network device and a third network device according to the positioning request so that the first network device and the second network device transmit a first network message and a second network message respectively according to the positioning initial information; and receiving, by the end device, the first network message and the second network message according to the positioning initial information. Next, the positioning method further comprises: determining, by the end device, first path loss information and second path loss information between the end device and the first network device and the second network device respectively according to the first network message and the second network message and transmitting, by the end device, the first path loss information and the second path loss information to the application server; transmitting, by the end device, an end network message according to the positioning initial information so that the third network device determines third path loss information between the third network device and the end device according to the end network message and the positioning initial information and transmits the third path loss information to the application server; and deciding, by the application server, an end position of the end device according to a first position of the first network device, a second position of the second network device, a third position of the third network device, the first path loss information, the second path loss information and the third path loss information.

The disclosure still further includes a positioning method for use in an LPWAN system. The LPWAN system comprises an application server and an end device. The positioning method comprises: receiving, by the application server, a positioning request from the end device; transmitting, by the application server, a positioning initial information to the end device, a first network device, a second network device and a third network device according to the positioning request; transmitting, by the end device, an end network message according to the positioning initial information so that the first network device, the second network device and the third network device determine first path loss information, second path loss information and third path loss information between the end device and the first network device, the second network device and the third network device respectively according to the end network message and the positioning initial information and transmit the first path loss information, the second path loss information and the third path loss information to the application server.

Next, the positioning method further comprises: deciding, by the application server, an end position of the end device according to a first position of the first network device, a second position of the second network device, a third position of the third network device, the first path loss information, the second path loss information and the third path loss information.

The disclosure also includes a positioning method for use in an LPWAN system. The LPWAN system comprises an application server and an end device. The positioning method comprises: receiving, by the application server, a positioning request from the end device; transmitting, by the application server, a positioning initial information to the end device, a first network device, a second network device and a third network device according to the positioning request so that the first network device transmits a first network message according to the positioning initial information; receiving, by the end device, the first network message according to the positioning initial information; determining, by the end device, first path loss information between the end device and the first network device according to the first network message, and transmitting, by the end device, the first path loss information to the application server. Next, the positioning method further comprises: transmitting, by the end device, an end network message according to the positioning initial information so that the second network device and the third network device determine second path loss information and third path loss information between the second network device and the third network device and the end device respectively according to the end network message and the positioning initial information and transmit the second path loss information and the third path loss information to the application server; and deciding, by the application server, an end position of the end device according to a first position of the first network device, a second position of the second network device, a third position of the third network device, the first path loss information, the second path loss information and the third path loss information.

The disclosure additionally includes an LPWAN system, which comprises an application server and an end device. The application server comprises a server processor and a server transceiver. The end device comprises a device processor and a device transceiver. The application server and the end device are configured to accomplish the steps of the aforesaid methods.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an LPWAN system according to a first embodiment of the present invention;

FIG. 1B is a block diagram of an application server according to the first embodiment of the present invention;

FIG. 1C is a block diagram of an end device according to the first embodiment of the present invention;

FIG. 2A is a schematic view of an LPWAN system according to a second embodiment of the present invention;

FIG. 2B is a block diagram of an application server according to the second embodiment of the present invention;

FIG. 2C is a block diagram of an end device according to the second embodiment of the present invention;

FIG. 2D is a schematic view of an exemplary example of the LPWAN system according to the second embodiment of the present invention;

FIG. 3A is a schematic view of an LPWAN system according to a third embodiment of the present invention;

FIG. 3B is a block diagram of an application server according to the third embodiment of the present invention;

FIG. 3C is a block diagram of an end device according to the third embodiment of the present invention;

FIG. 3D is a schematic view of an exemplary example of the LPWAN system according to the third embodiment of the present invention;

FIG. 4A is a schematic view of an LPWAN system according to a fourth embodiment of the present invention;

FIG. 4B is a block diagram of an application server according to the fourth embodiment of the present invention;

FIG. 4C is a block diagram of an end device according to the fourth embodiment of the present invention;

FIG. 4D is a schematic view of an exemplary example of the LPWAN system according to the fourth embodiment of the present invention;

FIG. 5A is a schematic view of an LPWAN system according to a fifth embodiment of the present invention;

FIG. 5B is a block diagram of an application server according to the fifth embodiment of the present invention;

FIG. 5C is a block diagram of an end device according to the fifth embodiment of the present invention;

FIG. 5D is a schematic view of an exemplary example of the LPWAN system according to the fifth embodiment of the present invention;

FIG. 6 is a flowchart diagram of a positioning method according to a sixth embodiment of the present invention;

FIG. 7 is a flowchart diagram of a positioning method according to a seventh embodiment of the present invention;

FIG. 8 is a flowchart diagram of a positioning method according to an eighth embodiment of the present invention; and

FIG. 9 is a flowchart diagram of a positioning method according to a ninth embodiment of the present invention.

### DETAILED DESCRIPTION

In the following description, the present invention will be explained with reference to certain example embodiments thereof. It shall be appreciated that, these example embodiments are not intended to limit the present invention to any particular examples, embodiments, environment, applications or implementations described in these example embodiments. Therefore, description of these example embodiments is only for purpose of illustration rather than to limit the present invention, and the scope claimed in this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

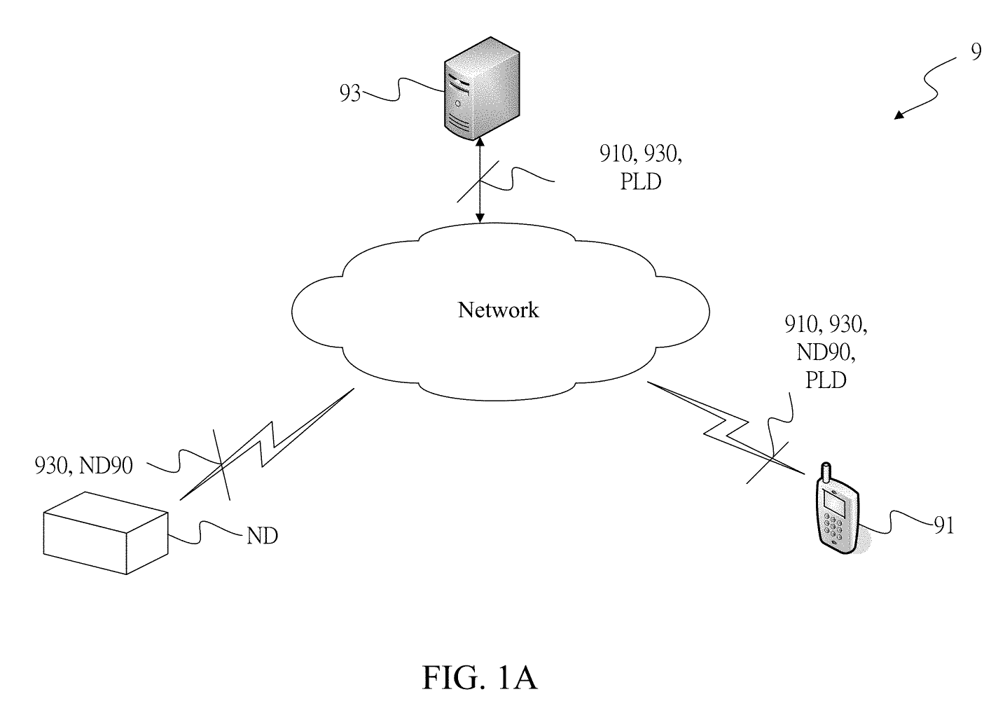

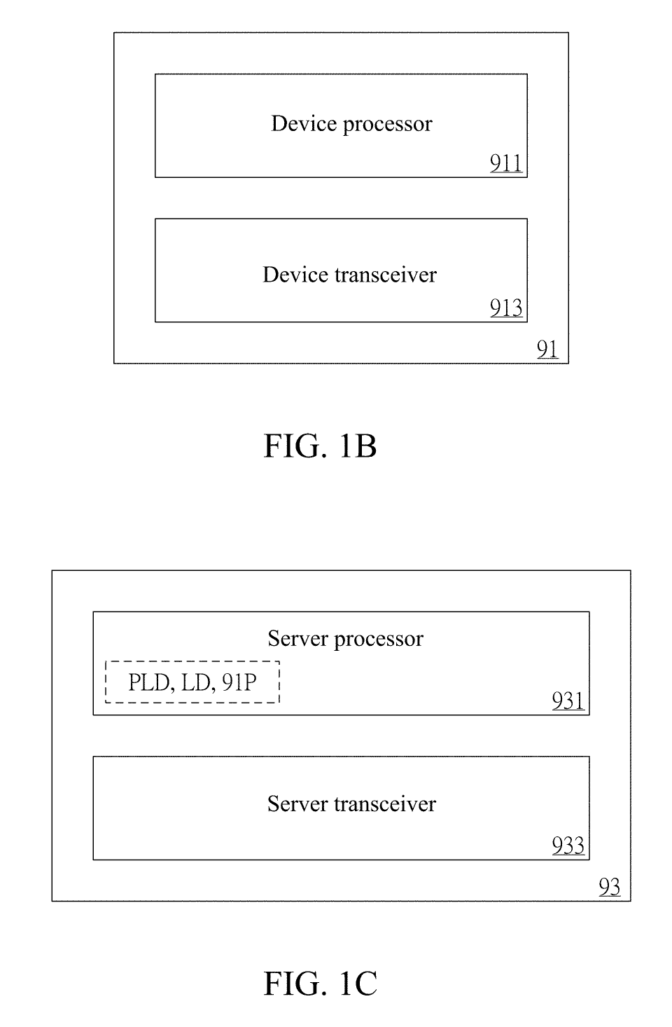

Please refer to FIG. 1A to FIG. 1C together. FIG. 1A is a schematic view of a low power wide area network (LPWAN) system 9 according to a first embodiment of the present invention. The LPWAN system 9 comprises an end device 91 and an application server 93.

FIG. 1B is a block diagram of the end device 91 according to the first embodiment of the present invention, and the end device 91 comprises a device processor 911 and a device transceiver 913. FIG. 1C is a block diagram of an application server 93 according to the first embodiment of the present invention, and the application server 93 comprises a server processor 931 and a server transceiver 933. These elements are electrically connected together, and interactions among these elements will be further described hereinafter.

First, when the position of the end device 91 needs to be determined in the LPWAN system 9, the device processor 911 of the end device 91 utilizes the device transceiver 913 to transmit a positioning request 910 to the application server 93 at the back end via the network. On the other hand, the server processor 931 of the application server 93 utilizes the server transceiver 133 to receive the positioning request 110 via the network.

Next, the server processor 931 of the application server 93 utilizes the server transceiver 933 to transmit a positioning initial information 930 to the end device 91 and at least one network device ND via the network according to the positioning request 910. The positioning initial information 930 is mainly used to notify the end device 91 to initiate a positioning procedure and notify the at least one network device ND to assist in the positioning of the end device 91.

Thereafter, after receiving the positioning initial information 930, the at least one network device ND transmits at least one network message ND90. Accordingly, the device processor 911 of the end device 91 can utilize the device transceiver 913 to receive the at least one network message ND90 via the network in a listen window. Next, the device processor 911 of the end device 91 determines at least one path loss information PLD between the end device 91 and the corresponding at least one network device ND according to the at least one network message ND90, and utilizes the device transceiver 913 to transmit the at least one path loss information PLD to the application server 93 via the network.

On the other hand, the server processor 931 of the application server 93 may decide an end position 91P of the end device 91 according to at least one position LD of the at least one network device ND and the at least one path loss information PLD after the server transceiver 933 receives the at least one path loss information PLD.

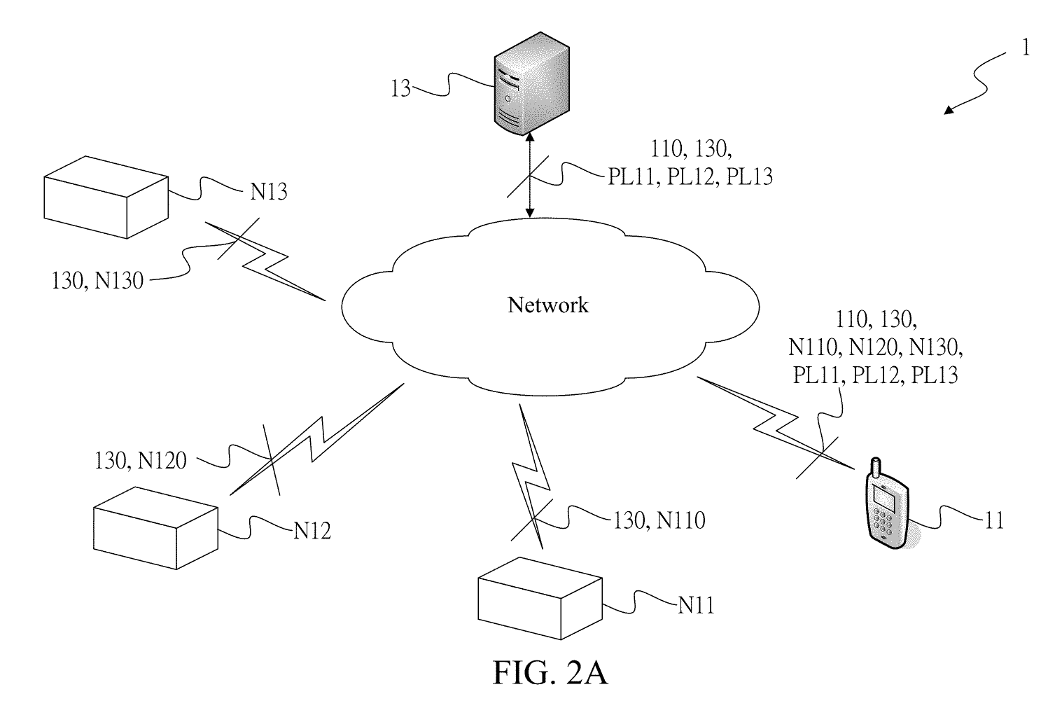

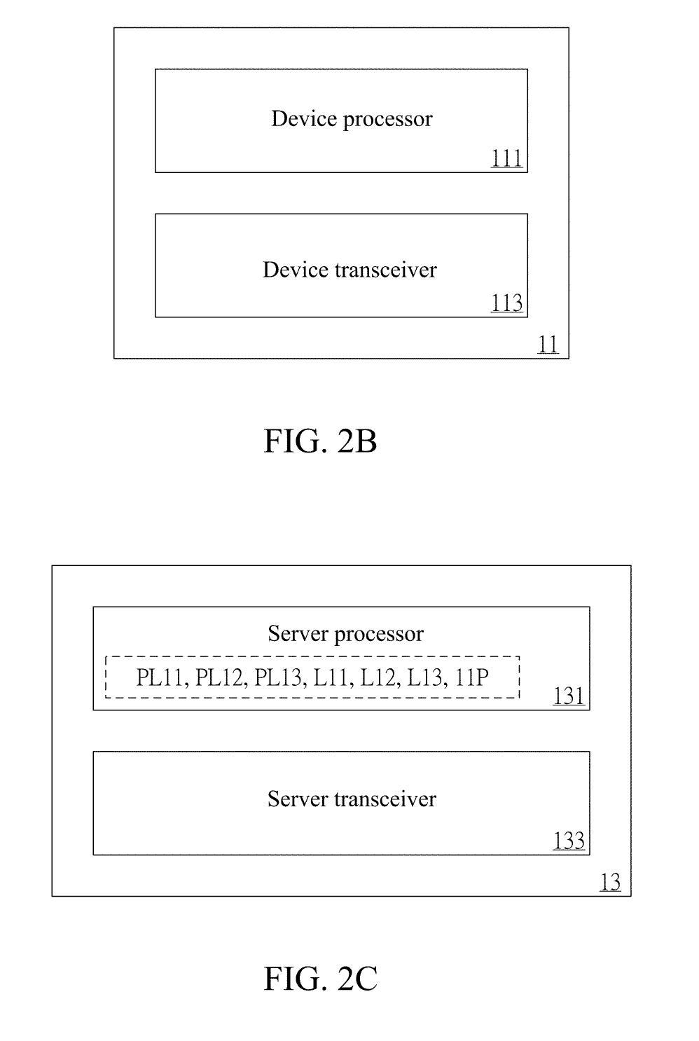

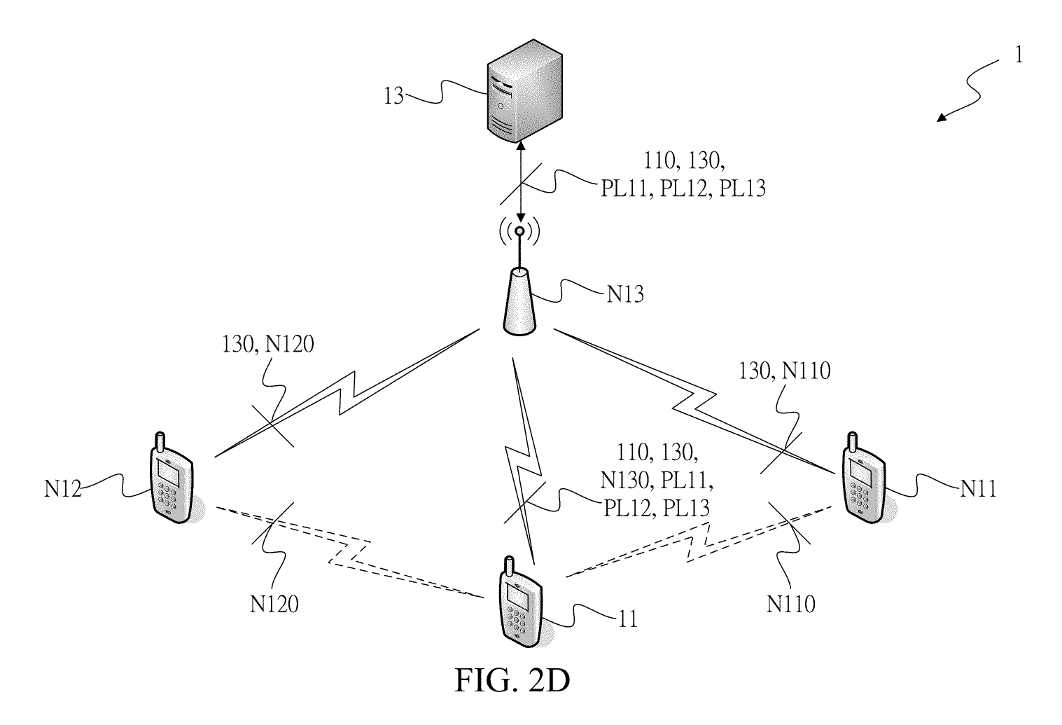

Please refer to FIG. 2A to FIG. 2C together. FIG. 2A is a schematic view of a low power wide area network (LPWAN) system 1 according to a second embodiment of the present invention. The LPWAN system 1 comprises an end device 11 and an application server 13. FIG. 2B is a block diagram of the end device 11 according to the second embodiment of the present invention, and the end device 11 comprises a device processor 111 and a device transceiver 113. FIG. 2C is a block diagram of an application server 13 according to the second embodiment of the present invention, and the application server 13 comprises a server processor 131 and a server transceiver 133. These elements are electrically connected together, and interactions among these elements will be further described hereinafter.

First, when the position of the end device 11 needs to be determined in the LPWAN system 1, the device processor 111 of the end device 11 utilizes the device transceiver 113 to transmit a positioning request 110 to the application server 13 at the back end via the network. On the other hand, the server processor 131 of the application server 13 utilizes the server transceiver 133 to receive the positioning request 110 via the network.

Next, the server processor 131 of the application server 13 utilizes the server transceiver 133 to transmit a positioning initial information 130 to the end device 11, a first network device N11, a second network device N12 and a third network device N13 via the network according to the positioning request 110. The positioning initial information 130 is mainly used to notify the end device 11 to initiate a positioning procedure and notify the first network device N11, the second network device N12 and the third network device N13 to assist in the positioning of the end device 11.

Thereafter, after receiving the positioning initial information 130, the first network device N11, the second network device N12 and the third network device N13 transmit a first network message N110, a second network message N120 and a third network message N130 respectively. Accordingly, the device processor 111 of the end device 11 can utilize the device transceiver 113 to receive the first network message N110, the second network message N120 and the third network message N130 via the network in a listen window. Next, the device processor 111 of the end device 11 determines first path loss information PL11 between the end device 11 and the corresponding first network device N11 according to the first network message N110. Similarly, the device processor 111 of the end device 11 determines second path loss information PL12 and third path loss information PL13 respectively between the end device 11 and the second network device N12 and the third network device N13 according to the second network message N120 and the third network message N130, and utilizes the device transceiver 113 to transmit the first path loss information PL11, the second path loss information PL12 and the third path loss information PL13 to the application server 13 via the network.

On the other hand, the server processor 131 of the application server 13 may decide an end position 11P of the end device 11 according to a first position L11 of the first network device N11, a second position L12 of the second network device N12, a third position L13 of the third network device N13, the first path loss information PL11, the second path loss information PL12 and the third path loss information PL13 after the server transceiver 133 receives the first path loss information PL11, the second path loss information PL12 and the third path loss information PL13.

Further speaking, the server processor 131 of the application server 13 is mainly configured to calculate distances between the end device 11 and the first network device N11, the second network device N12 and the third network device N13 respectively according to the first path loss information PL11, the second path loss information PL12 and the third path loss information PL13.

Accordingly, in the case where (1) the first position L11 of the first network device N11 and the distance between the first network device N11 and the end device 11; (2) the second position L12 of the second network device N12 and the distance between the second network device N12 and the end device 11; and (3) the third position L13 of the third network device N13 and the distance between the third network device N13 and the end device 11 are all known, the server processor 131 of the application server 13 can directly calculate the end position 11P.

It shall be particularly appreciated that, how to determine the distance according to the path loss information (e.g., by using a path loss wireless channel model) and how to calculate a specific position according to the position and the distance shall be appreciated by those skilled in the art, and thus will not be further described herein. The present invention mainly focuses on how to assist in determining the correct position of the end device according to the interaction information between the end device and the network devices in the LPWAN system.

Additionally, categories and transmission objects of the first network message N110, the second network message N120 and the third network message N130 described above may vary depending on the property of the network devices. In detail, the first network device

N11, the second network device N12 or the third network device N13 may be one of a mobile device and a gateway server. Therefore, when the first network device N11, the second network device N12 or the third network device N13 is the mobile device, the first network message N110, the second network message N120 or the third network message N130 may correspondingly be an uplink message transmitted to the gateway server connected with the network device.

On the other hand, when the first network device N11, the second network device N12 or the third network device N13 is the gateway server, the first network message N110, the second network message N120 or the third network message N130 may correspondingly be a downlink message transmitted to the end device 11.

Please further refer to FIG. 2D, which is a schematic view of an exemplary example of the LPWAN system 1 according to the second embodiment of the present invention. In this exemplary example, the first network device N11 and the second network device N12 are mobile devices, and the third network device N13 is a gateway server. The end device 11, the first network device N11 and the second network device N12 transmit signals with the application server 13 via the third network device N13.

Specifically, when the position of the end device 11 needs to be determined in the LPWAN system 1, the end device 11 transmits a positioning request 110 to the application server 13 via the third network device N13. The application server 13 transmits a positioning initial information 130 to the end device 11, the first network device N11 and the second network device N12 via the third network device N13 according to the positioning request 110.

Thereafter, the first network device N11 and the second network device N12 transmit uplink messages (i.e., the first network message N110 and the second network message N120) to the gateway server (i.e., the third network device N13) according to the positioning initial information 130 because the first network device N11 and the second network device N12 are mobile devices. On the other hand, the third network device N13 directly transmits a downlink message (i.e., the third network message N130) to the end device 11 according to the positioning initial information 130 because the third network device N13 is a gateway server.

Because the end device 11 of the LPWAN system 1 is capable of listening uplink messages of other mobile devices (e.g., communication protocols of the LPWAN system of which the uplink and downlink messages have similar header formats, e.g., LoRa or apparatuses having Device-To-Device technology), so the end device 11 can receive the first network message N110, the second network message N120 and the third network message N130.

Next, the end device 11 determines first path loss information PL11, second path loss information PL12 and third path loss information PL13 between the end device 11 and the first network device N11, the second network device N12 and the third network device N13 respectively according to the first network message N110, the second network message N120 and the third network message N130, and transmits the first path loss information PL11, the second path loss information PL12 and the third path loss information PL13 to the application server 13 via the third network device N13.

On the other hand, after receiving the first path loss information PL11, the second path loss information PL12 and the third path loss information PL13, the application server 13 decides the end position 11P of the end device 11 according to the first position L11 of the first network device N11, the second position L12 of the second network device N12, the third position L13 of the third network device N13, the first path loss information PL11, the second path loss information PL12 and the third path loss information PL13.

It shall be particularly appreciated that, in this exemplary example, the third position L13 is substantially information known to the application server 13 because the third network device N13 is the gateway server. Moreover, the first network device N11 and the second network device N12 are mobile devices, so the first position L11 and the second position L12 may be reported by the devices themselves or may be calculated by the application server 13 via the aforesaid method using other network devices in the network. Accordingly, the first position L11, the second position L12 and the third position L13 may all be regarded as the information known to the application server 13.

It shall be additionally noted that, contents shown in the aforesaid exemplary example are mainly for the purpose of making it easier to understand that the categories and transmission objects of the network messages in the present invention may vary depending on the property of the network devices, instead of limiting the implementation of the network devices of the present invention.

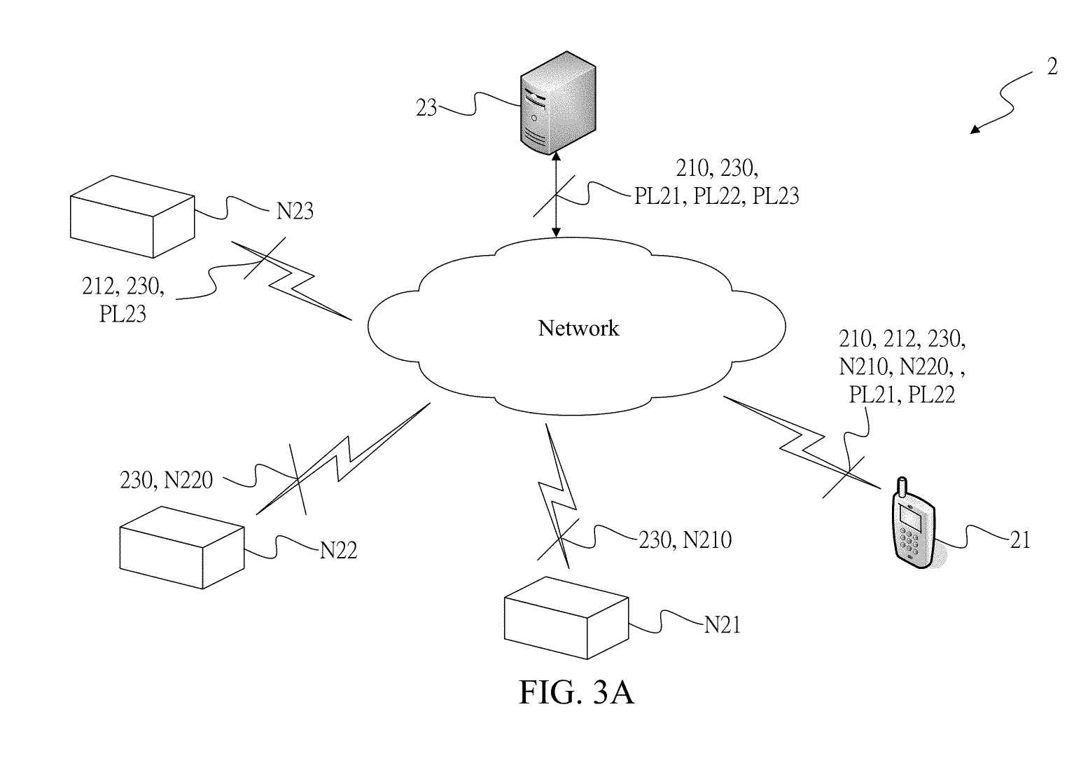

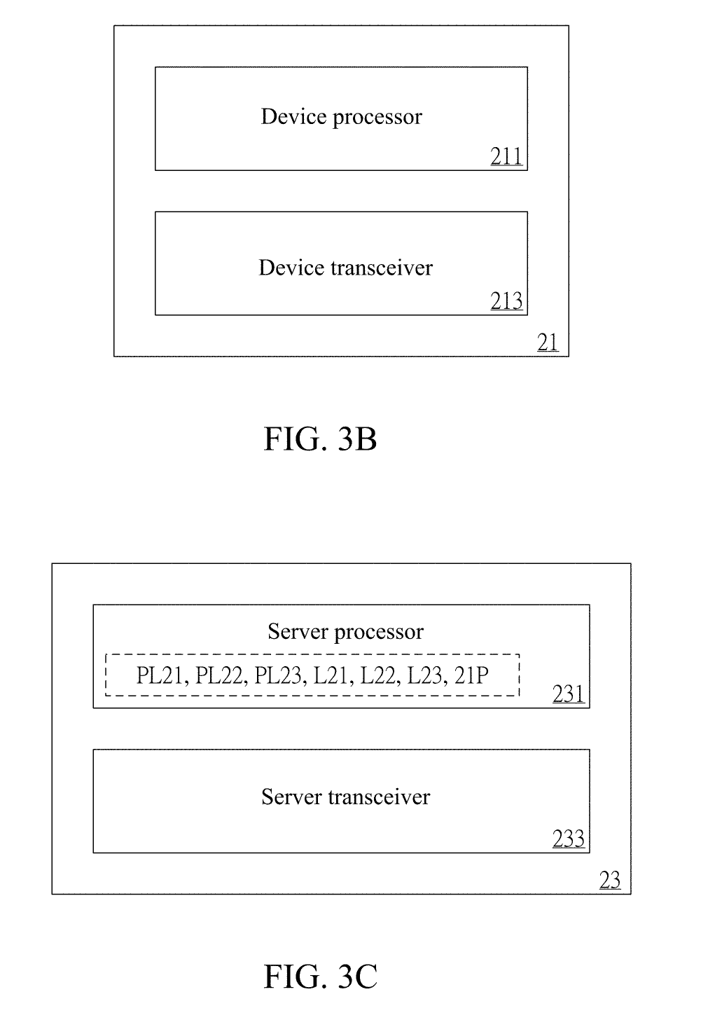

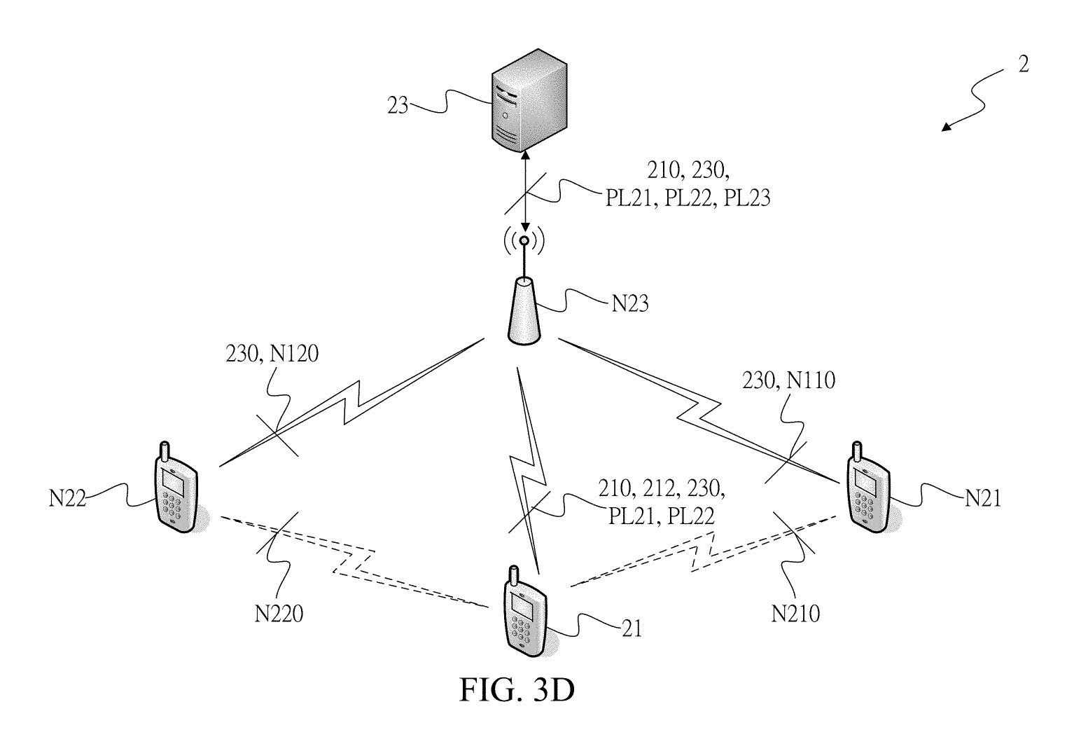

Please refer to FIG. 3A to FIG. 3C together. FIG. 3A is a schematic view of an LPWAN system 2 according to a third embodiment of the present invention. The LPWAN system 2 comprises an end device 21 and an application server 23. FIG. 3B is a block diagram of the end device 21 according to the third embodiment of the present invention, and the end device 21 comprises a device processor 211 and a device transceiver 213. FIG. 3C is a block diagram of an application server 23 according to the third embodiment of the present invention, and the application server 23 comprises a server processor 231 and a server transceiver 233. These elements are electrically connected together, and interactions among these elements will be further described hereinafter.

First, when the position of the end device 21 needs to be determined in the LPWAN system 2, the device processor 211 of the end device 21 utilizes the device transceiver 213 to transmit a positioning request 210 to the application server 23 at the back end via the network. On the other hand, the server processor 231 of the application server 23 utilizes the server transceiver 233 to receive the positioning request 210 via the network.

Next, the server processor 231 of the application server 23 utilizes the server transceiver 233 to transmit a positioning initial information 230 to the end device 21, a first network device N21, a second network device N22 and a third network device N23 via the network according to the positioning request 210. Similarly, the positioning initial information 230 is mainly used to notify the end device 21 to initiate a positioning procedure and notify the first network device N21, the second network device N22 and the third network device N23 to assist in the positioning of the end device 21.

Thereafter, after receiving the positioning initial information 230, the first network device N21 and the second network device N22 transmit a first network message N210 and a second network message N220 respectively. Accordingly, the device processor 211 of the end device 21 can utilize the device transceiver 213 to receive the first network message N210 and the second network message N220 via the network.

Next, the device processor 211 of the end device 21 determines first path loss information PL21 between the end device 21 and the corresponding first network device N21 according to the first network message N210. Similarly, the device processor 211 of the end device 21 determines second path loss information PL22 between the end device 21 and the second network device N22 according to the second network message N220, and utilizes the device transceiver 213 to transmit the first path loss information PL21 and the second path loss information PL22 to the application server 23 via the network.

Furthermore, the device processor 211 of the end device 21 utilizes the device transceiver 213 to further transmit an end network message 212 via the network according to the positioning initial information 230. Accordingly, the third network device N23 can receive the end network message 212 via the network and accordingly determine third path loss information PL23 between the end device 21 and the third network device N23. Thereafter, the third network device N23 transmits the third path loss information PL23 to the application server 23 via the network.

On the other hand, the server processor 231 of the application server 23 may decide an end position 21P of the end device 21 according to a first position L21 of the first network device N21, a second position L22 of the second network device N22, a third position L23 of the third network device N23, the first path loss information PL21, the second path loss information PL22 and the third path loss information PL23 after the server transceiver 233 receives the first path loss information PL21, the second path loss information PL22 and the third path loss information PL23.

It shall also be particularly appreciated that, how to determine the distance according to the path loss information (e.g., by using a path loss wireless channel model) and how to calculate a specific position according to the position and the distance shall be appreciated by those skilled in the art, and thus will not be further described herein. The present invention mainly focuses on how to assist in determining the correct position of the end device according to the interaction information between the end device and the network devices in the LPWAN system.

Moreover, the aforesaid end network message 212 is an uplink message transmitted to the gateway server. Similarly, the first network device N21, the second network device N22 or the third network device N23 may be one of a mobile device and a gateway server. Therefore, when the first network device N21 or the second network device N22 is the mobile device, the first network message N210 or the second network message N220 may correspondingly be an uplink message transmitted to the gateway server connected with the network device. On the other hand, when the first network device N21 or the second network device N22 is the gateway server, the first network message N210 or the second network message N220 may correspondingly be a downlink message transmitted to the end device 21.

Please further refer to FIG. 3D, which is a schematic view of an exemplary example of the LPWAN system 2 according to the third embodiment of the present invention. In this exemplary example, the first network device N21 and the second network device N22 are mobile devices, and the third network device N23 is a gateway server. The end device 21, the first network device N21 and the second network device N22 transmit signals with the application server 23 via the third network device N23.

Specifically, when the position of the end device 21 needs to be determined in the LPWAN system 2, the end device 21 transmits a positioning request 210 to the application server 23 via the third network device N23. The application server 23 transmits a positioning initial information 230 to the end device 21, the first network device N21 and the second network device N22 via the third network device N23 according to the positioning request 210.

Thereafter, the first network device N21 and the second network device N22 transmit uplink messages (i.e., the first network message N210 and the second network message N220) to the gateway server (i.e., the third network device N23) according to the positioning initial information 230 because the first network device N21 and the second network device N22 are mobile devices. Similarly, because the end device 21 of the LPWAN system 2 is capable of listening uplink messages of other mobile devices, the end device 21 can receive the first network message N210 and the second network message N220.

Next, the end device 21 determines first path loss information PL21 and second path loss information PL22 between the end device 21 and the first network device N21 and the second network device N22 respectively according to the first network message N210 and the second network message N220, and transmits the first path loss information PL21 and the second path loss information PL22 to the application server 23 via the third network device N23.

Furthermore, the end device 21 transmits the end network message 212 according to the positioning initial information 230 so that the third network device N23 can determine third path loss information PL23 between the third network device N23 and the end device 21 according to the end network message 212 and directly transmit the third path loss information PL23 to the application server 23.

On the other hand, after receiving the first path loss information PL21, the second path loss information PL22 and the third path loss information PL23, the application server 23 decides the end position 21P of the end device 21 according to the first position L21 of the first network device N21, the second position L22 of the second network device N22, the third position L23 of the third network device N23, the first path loss information PL21, the second path loss information PL22 and the third path loss information PL23.

Similarly, in this exemplary example, the third position L23 is substantially information known to the application server 23 because the third network device N23 is the gateway server. Moreover, the first network device N21 and the second network device N22 are mobile devices, so the first position L21 and the second position L22 may be reported by the devices themselves or may be calculated by the application server 23 via the aforesaid method using other network devices in the network. Accordingly, the first position L21, the second position L22 and the third position L23 may all be regarded as the information known to the application server 23.

It shall be additionally noted that, contents shown in the aforesaid exemplary example are mainly for the purpose of making it easier to understand that the categories and transmission objects of the network messages in the present invention may vary depending on the property of the network devices, instead of limiting the implementation of the network devices of the present invention.

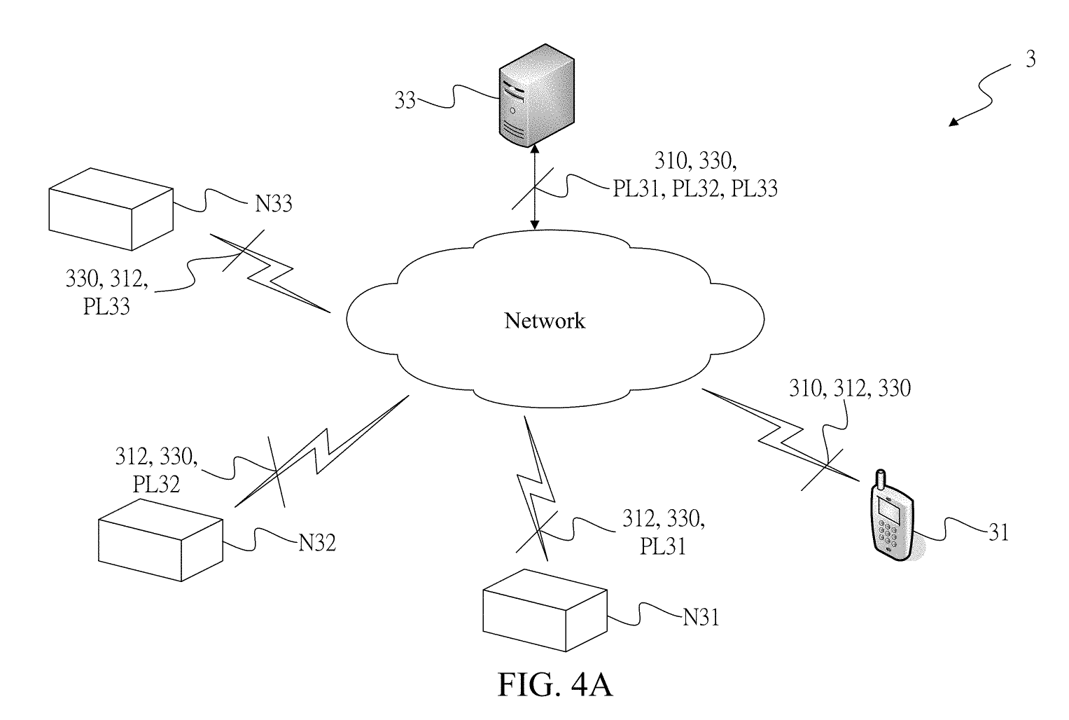

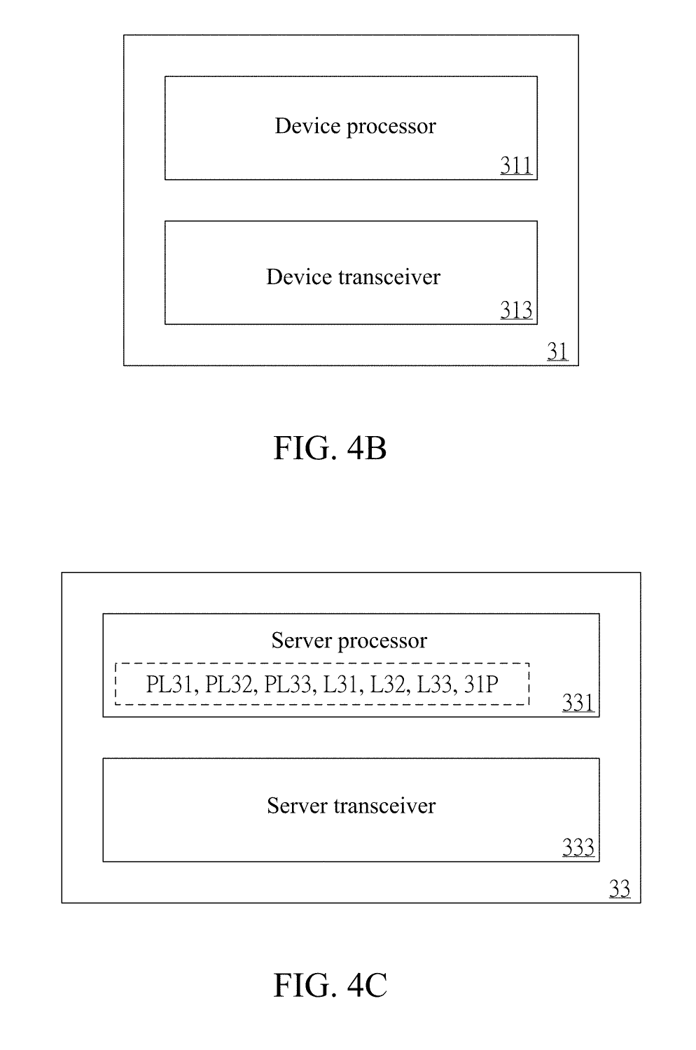

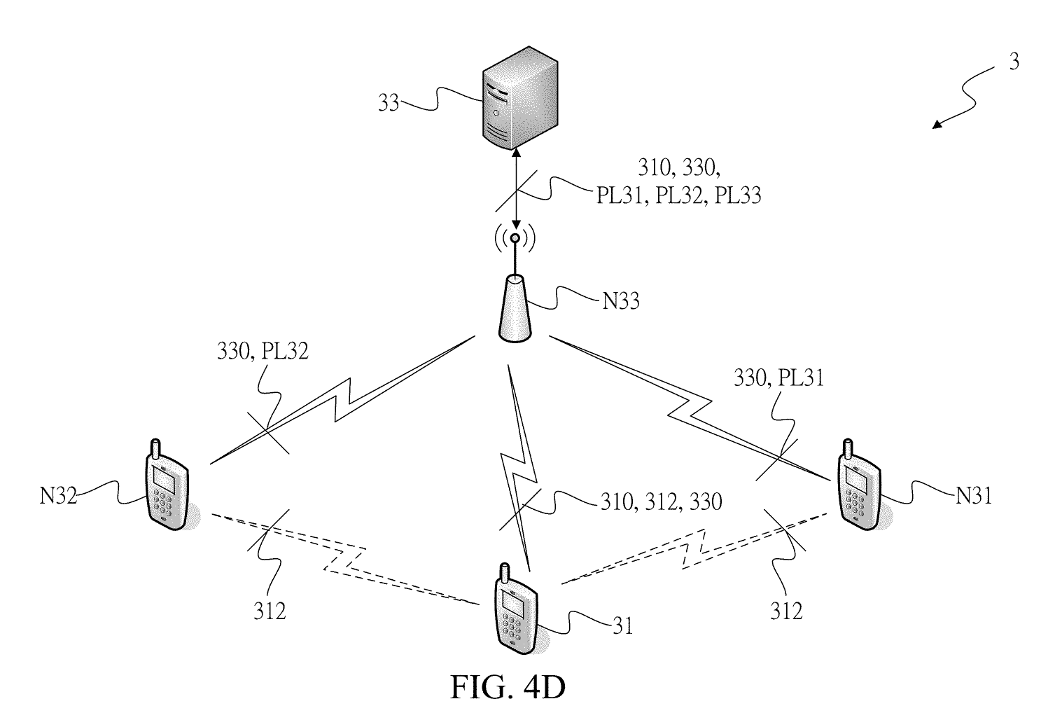

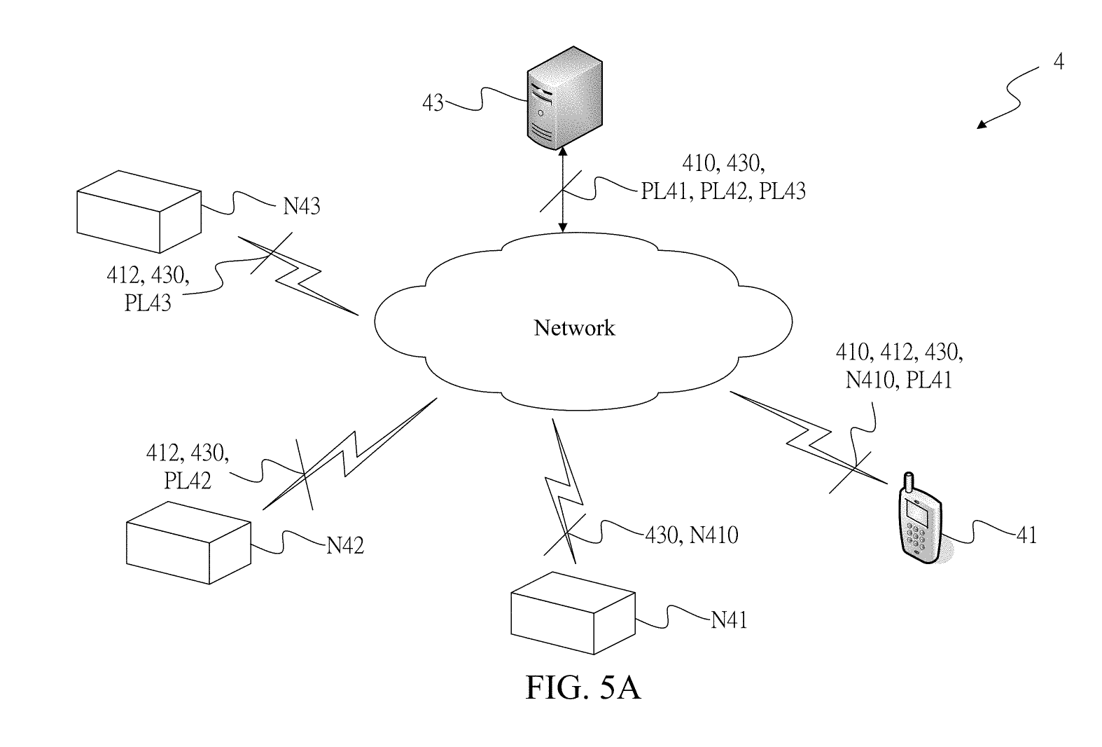

Please refer to FIG. 4A to FIG. 4C together. FIG. 4A is a schematic view of an LPWAN system 3 according to a fourth embodiment of the present invention. The LPWAN system 3 comprises an end device 31 and an application server 33. FIG. 4B is a block diagram of the end device 31 according to the fourth embodiment of the present invention, and the end device 31 comprises a device processor 311 and a device transceiver 313. FIG. 4C is a block diagram of an application server 33 according to the fourth embodiment of the present invention, and the application server 33 comprises a server processor 331 and a server transceiver 333. These elements are electrically connected together, and interactions among these elements will be further described hereinafter.

First, when the position of the end device 31 needs to be determined in the LPWAN system 3, the device processor 311 of the end device 31 utilizes the device transceiver 313 to transmit a positioning request 310 to the application server 33 at the back end via the network. On the other hand, the server processor 331 of the application server 33 utilizes the server transceiver 333 to receive the positioning request 310 via the network.

Next, the server processor 331 of the application server 33 utilizes the server transceiver 333 to transmit a positioning initial information 330 to the end device 31, a first network device N31, a second network device N32 and a third network device N33 via the network according to the positioning request 310. The positioning initial information 330 is mainly used to notify the end device 31 to initiate a positioning procedure and notify the first network device N31, the second network device N32 and the third network device N33 to assist in the positioning of the end device 31.

Thereafter, after the device transceiver 313 receives the positioning initial information 330, the device processor 311 of the end device 31 can accordingly utilize the device transceiver 313 to transmit an end network message 312 via the network. Therefore, after receiving the end network message 312, the first network device N31, the second network device N32 and the third network device 33 accordingly determine first path loss information PL31, second path loss information PL32 and third path loss information PL33 respectively between the end device 31 and first network device N31, the second network device N32 and the third network device N33, and respectively transmit the first path loss information PL31, the second path loss information PL32 and the third path loss information PL33 to the application server 33.

On the other hand, the server processor 331 of the application server 33 may decide an end position 31P of the end device 31 according to a first position L31 of the first network device N31, a second position L32 of the second network device N32, a third position L33 of the third network device N33, the first path loss information PL31, the second path loss information PL32 and the third path loss information PL33 after the server transceiver 333 receives the first path loss information PL31, the second path loss information PL32 and the third path loss information PL33.

It shall also be particularly appreciated that, how to determine the distance according to the path loss information (e.g., by using a path loss wireless channel model) and how to calculate a specific position according to the position and the distance shall be appreciated by those skilled in the art, and thus will not be further described herein. The present invention mainly focuses on how to assist in determining the correct position of the end device according to the interaction information between the end device and the network devices in the LPWAN system.

Additionally, the aforesaid end network message 312 is an uplink message transmitted to the gateway server. Similarly, the first network device N31, the second network device N32 or the third network device N33 may be one of a mobile device and a gateway server.

Please further refer to FIG. 4D, which is a schematic view of an exemplary example of the LPWAN system 3 according to the fourth embodiment of the present invention. In this exemplary example, the first network device N31 and the second network device N32 are mobile devices, and the third network device N33 is a gateway server. The end device 31, the first network device N31 and the second network device N32 transmit signals with the application server 33 via the third network device N33.

Specifically, when the position of the end device 31 needs to be determined in the LPWAN system 3, the end device 31 transmits a positioning request 310 to the application server 33 via the third network device N33. The application server 33 transmits a positioning initial information 330 to the end device 31, the first network device N31 and the second network device N32 via the third network device N33 according to the positioning request 310. The end device 31 transmits an uplink message (i.e., the end network message 312) to the third network device N33 according to the positioning initial information 330. Thereafter, because the first network device N31 and the second network device N32 of the LPWAN system 3 are mobile devices and are capable of listening uplink messages of other mobile devices, the first network device N31, the second network device N32 and the third network device N33 all can receive the end network message 312 and accordingly determine the first path loss information PL31, the second path loss information PL32 and the third path loss information PL33 respectively.

Next, the first network device N31 and the second network device N32 respectively transmit the first path loss information PL31 and the second path loss information PL32 to the application server 33 via the third network device N33. Additionally, the third network device N33 can also transmit the third path loss information PL33 to the application server 33 by itself.

Then, after receiving the first path loss information PL31, the second path loss information PL32 and the third path loss information PL33, the application server 33 decides the end position 31P of the end device 31 according to the first position L31 of the first network device N31, the second position L32 of the second network device N32, the third position L33 of the third network device N33, the first path loss information PL31, the second path loss information PL32 and the third path loss information PL33.

Similarly, in this exemplary example, the third position L33 is substantially information known to the application server 33 because the third network device N13 is the gateway server. Moreover, the first network device N31 and the second network device N32 are mobile devices, so the first position L31 and the second position L32 may be reported by the devices themselves or may be calculated by the application server 33 via the aforesaid method using other network devices in the network. Accordingly, the first position L31, the second position L32 and the third position L33 may all be regarded as the information known to the application server 33.

It shall be additionally noted that, contents shown in the aforesaid exemplary example are mainly for the purpose of making it easier to understand that the categories and transmission objects of the network messages in the present invention may vary depending on the property of the network devices, instead of limiting the implementation of the network devices of the present invention.

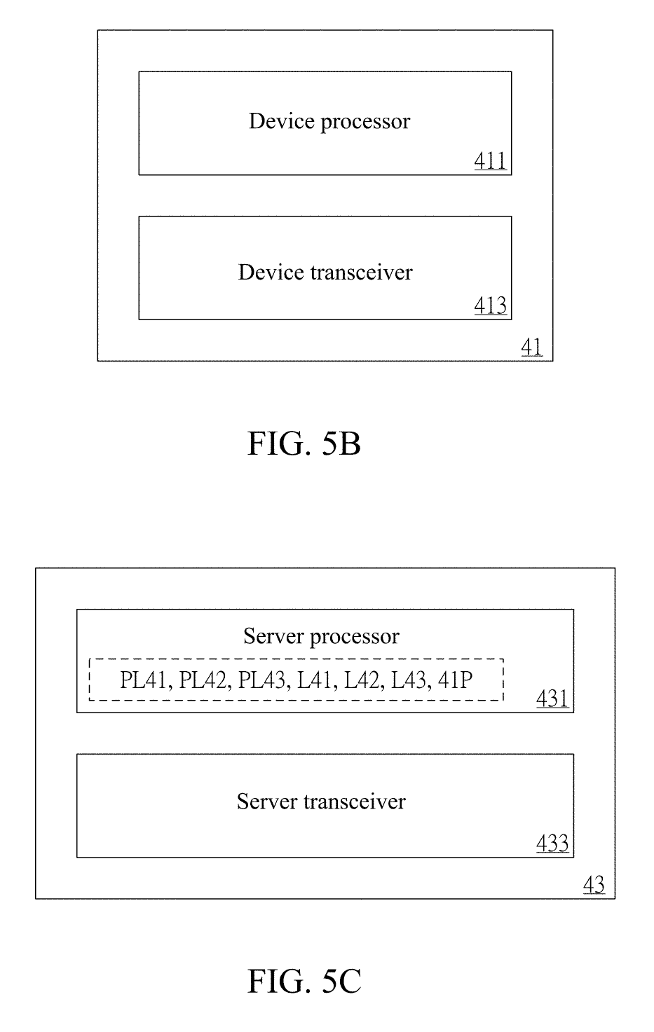

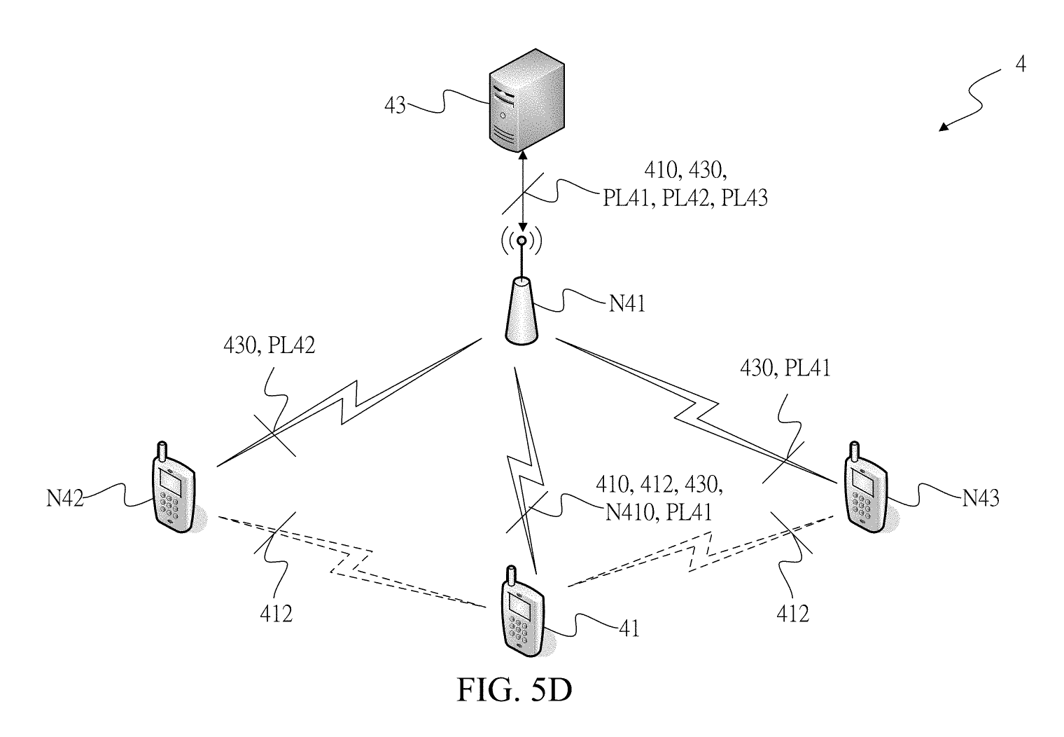

Please refer to FIG. 5A to FIG. 5C together. FIG. 5A is a schematic view of an LPWAN system 4 according to a fifth embodiment of the present invention. The LPWAN system 4 comprises an end device 41 and an application server 43. FIG. 5B is a block diagram of the end device 41 according to the fifth embodiment of the present invention, and the end device 41 comprises a device processor 411 and a device transceiver 413. FIG. 5C is a block diagram of an application server 43 according to the fifth embodiment of the present invention, and the application server 43 comprises a server processor 431 and a server transceiver 433. These elements are electrically connected together, and interactions among these elements will be further described hereinafter.

First, when the position of the end device 41 needs to be determined in the LPWAN system 4, the device processor 411 of the end device 41 utilizes the device transceiver 413 to transmit a positioning request 410 to the application server 43 at the back end via the network. On the other hand, the server processor 431 of the application server 43 utilizes the server transceiver 433 to receive the positioning request 410 via the network.

Next, the server processor 431 of the application server 43 utilizes the server transceiver 433 to transmit a positioning initial information 430 to the end device 41, a first network device N41, a second network device N42 and a third network device N43 via the network according to the positioning request 410. The positioning initial information 430 is mainly used to notify the end device 41 to initiate a positioning procedure and notify the first network device N41, the second network device N42 and the third network device N43 to assist in the positioning of the end device 41.

Thereafter, after receiving the positioning initial information 430, the first network device N41 accordingly transmits a first network message N410 via the network. Accordingly, the device processor 411 of the end device 41 can utilize the device transceiver 413 to receive the first network message N410 via the network. The device processor 411 of the end device 41 determines first path loss information PL41 between the end device 41 and the corresponding first network device N41 according to the first network message N410, and utilizes the device transceiver 413 to transmit the first path loss information PL41 to the application server 43 via the network.

Furthermore, the device processor 411 of the end device 41 utilizes the device transceiver 413 to further transmit an end network message 412 via the network according to the positioning initial information 430. Accordingly, the second network device N42 and the third network device N43 can receive the end network message 412 via the network and accordingly determine second path loss information PL42 and third path loss information

PL43 between the end device 41 and the second network device N42 and the third network device N43 respectively. Then, the second network device N42 and the third network device N43 respectively transmit the second path loss information PL42 and the third path loss information PL43 to the application server 43 via the network. On the other hand, the server processor 431 of the application server 43 may decide an end position 41P of the end device 41 according to a first position L41 of the first network device N41, a second position L42 of the second network device N42, a third position L43 of the third network device N43, the first path loss information PL41, the second path loss information PL42 and the third path loss information PL43 after the server transceiver 433 receives the first path loss information PL41, the second path loss information PL42 and the third path loss information PL43.

It shall also be particularly appreciated that, how to determine the distance according to the path loss information (e.g., by using a path loss wireless channel model) and how to calculate a specific position according to the position and the distance shall be appreciated by those skilled in the art, and thus will not be further described herein. The present invention mainly focuses on how to assist in determining the correct position of the end device according to the interaction information between the end device and the network devices in the LPWAN system.

Moreover, the aforesaid end network message 412 is an uplink message transmitted to the gateway server. Similarly, the first network device N41, the second network device N42 or the third network device N43 may be one of a mobile device and a gateway server.

Therefore, when the first network device N21 is the mobile device, the first network message N410 may correspondingly be an uplink message transmitted to the gateway server connected with the first network device. On the other hand, when the first network device N41 is the gateway server, the first network message N410 may correspondingly be a downlink message transmitted to the end device 41.

Please further refer to FIG. 5D, which is a schematic view of an exemplary example of the LPWAN system 4 according to the fifth embodiment of the present invention. In this exemplary example, the first network device N41 is a gateway server, and the second network device N42 and the third network device N43 are mobile devices. The end device 41, the second network device N42 and the third network device N43 transmit signals with the application server 43 via the first network device N41.

Specifically, when the position of the end device 41 needs to be determined in the LPWAN system 4, the end device 41 transmits a positioning request 410 to the application server 43 via the first network device N41. The application server 43 transmits a positioning initial information 430 to the end device 41, the second network device N42 and the third network device N43 via the first network device N41 according to the positioning request 410.

Thereafter, the first network device N41 (i.e., the gateway server) accordingly transmits the first network message N410 to the end device 41 when transferring the positioning initial information 430 (or may regard the positioning initial information 430 being transferred as the first network message N410). Next, after receiving the first network message N410, the end device 41 accordingly determines first path loss information PL41 between the end device 41 and the corresponding first network device N41, and transmits the first path loss information PL41 to the application server 43.

Furthermore, the end device 41 further transmits an uplink message (i.e., the end network message 412) to the first network device N41 according to the positioning initial information 430. Because the second network device N42 and the third network device N43 of the LPWAN system 4 are mobile devices and are capable of listening uplink messages of other mobile devices, the second network device N42 and the third network device N43 can receive the end network message 412 and determine the second path loss information PL42 and the third path loss information PL43 respectively. Next, the second network device N42 and the third network device N43 transmit the second path loss information PL42 and the third path loss information PL43 respectively to the application server 43 via the first network device N41 (i.e., the gateway server).

On the other hand, after receiving the first path loss information PL41, the second path loss information PL42 and the third path loss information PL43, the application server 43 decides the end position 41P of the end device 41 according to the first position L41 of the first network device N41, the second position L42 of the second network device N42, the third position L43 of the third network device N43, the first path loss information PL41, the second path loss information PL42 and the third path loss information PL43.

Similarly, in this exemplary example, the first position L41 is substantially information known to the application server 43 because the first network device N41 is the gateway server. Moreover, the second network device N42 and the third network device N43 are mobile devices, so the second position L42 and the third position L43 may be reported by the devices themselves or may be calculated by the application server 43 via the aforesaid method using other network devices in the network. Accordingly, the first position L41, the second position L42 and the third position L43 may all be regarded as the information known to the application server 43.

It shall be additionally noted that, contents shown in the aforesaid exemplary example are mainly for the purpose of making it easier to understand that the categories and transmission objects of the network messages in the present invention may vary depending on the property of the network devices, instead of limiting the implementation of the network devices of the present invention.

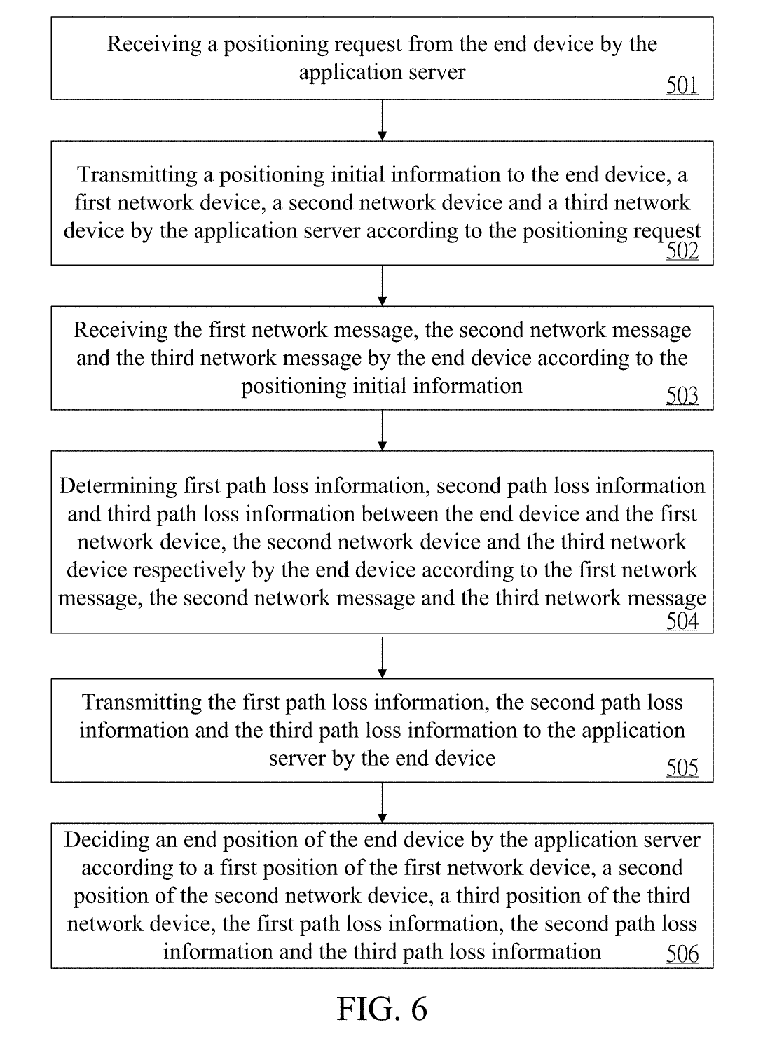

A sixth embodiment of the present invention is a positioning method, and a flowchart diagram thereof is as shown in FIG. 6. The method of the sixth embodiment is for use in an LPWAN system (e.g., the LPWAN system of the aforesaid embodiments). The LPWAN system comprises an application server and an end device. Detailed steps of the sixth embodiment are as follows.

First, step 501 is executed to receive a positioning request from the end device by the application server. Step 502 is executed to transmit a positioning initial information to the end device, a first network device, a second network device and a third network device by the application server according to the positioning request. The first network device, the second network device and the third network device transmit a first network message, a second network message and a third network message respectively according to the positioning initial information.

Next, step 503 is executed to receive the first network message, the second network message and the third network message by the end device according to the positioning initial information. Step 504 is executed to determine first path loss information, second path loss information and third path loss information between the end device and the first network device, the second network device and the third network device respectively by the end device according to the first network message, the second network message and the third network message.

Thereafter, step 505 is executed to transmit the first path loss information, the second path loss information and the third path loss information to the application server by the end device. Step 506 is executed to decide an end position of the end device by the application server according to a first position of the first network device, a second position of the second network device, a third position of the third network device, the first path loss information, the second path loss information and the third path loss information.

It shall be particularly appreciated that, in the sixth embodiment, each of the network devices is one of a mobile device and a gateway server. When network device is the mobile device, the corresponding network message is an uplink message transmitted to the gateway server. On the other hand, when the network device is the gateway server, the corresponding network message is a downlink message transmitted to the end device.

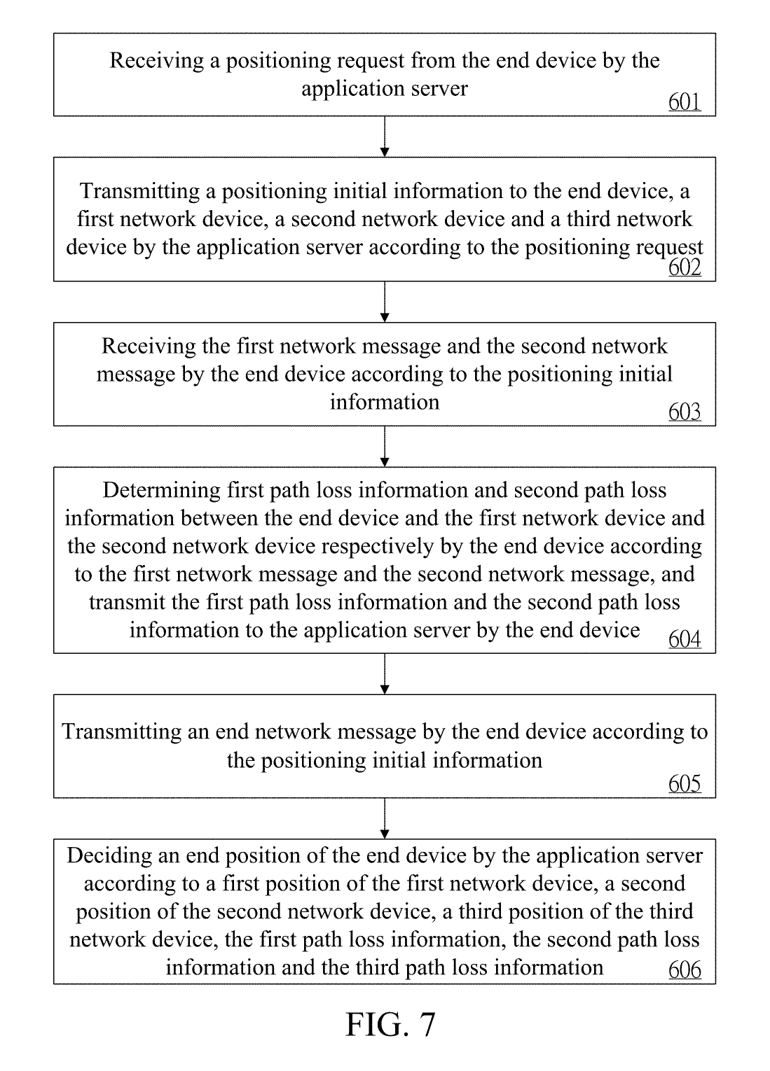

A seventh embodiment of the present invention is a positioning method, and a flowchart diagram thereof is as shown in FIG. 7. The method of the seventh embodiment is for use in an LPWAN system (e.g., the LPWAN system of the aforesaid embodiments). The LPWAN system comprises an application server and an end device. Detailed steps of the seventh embodiment are as follows.

First, step 601 is executed to receive a positioning request from the end device by the application server. Step 602 is executed to transmit a positioning initial information to the end device, a first network device, a second network device and a third network device by the application server according to the positioning request. The first network device and the second network device transmit a first network message and a second network message respectively according to the positioning initial information.

Next, step 603 is executed to receive the first network message and the second network message by the end device according to the positioning initial information. Step 604 is executed to determine first path loss information and second path loss information between the end device and the first network device and the second network device respectively by the end device according to the first network message and the second network message, and transmit the first path loss information and the second path loss information to the application server by the end device.

Step 605 is executed to transmit an end network message by the end device according to the positioning initial information. The third network device determines third path loss information between the third network device and the end device according to the end network message and the positioning initial information and transmits the third path loss information to the application server. Finally, step 606 is executed to decide an end position of the end device by the application server according to a first position of the first network device, a second position of the second network device, a third position of the third network device, the first path loss information, the second path loss information and the third path loss information.

It shall be particularly appreciated that, in the seventh embodiment, the end network message is an uplink message transmitted to a gateway server. Each of the network devices is one of a mobile device and the gateway server. When the network device is the mobile device, the corresponding network message is an uplink message transmitted to the gateway server. On the other hand, when the network device is the gateway server, the corresponding network message is a downlink message transmitted to the end device.

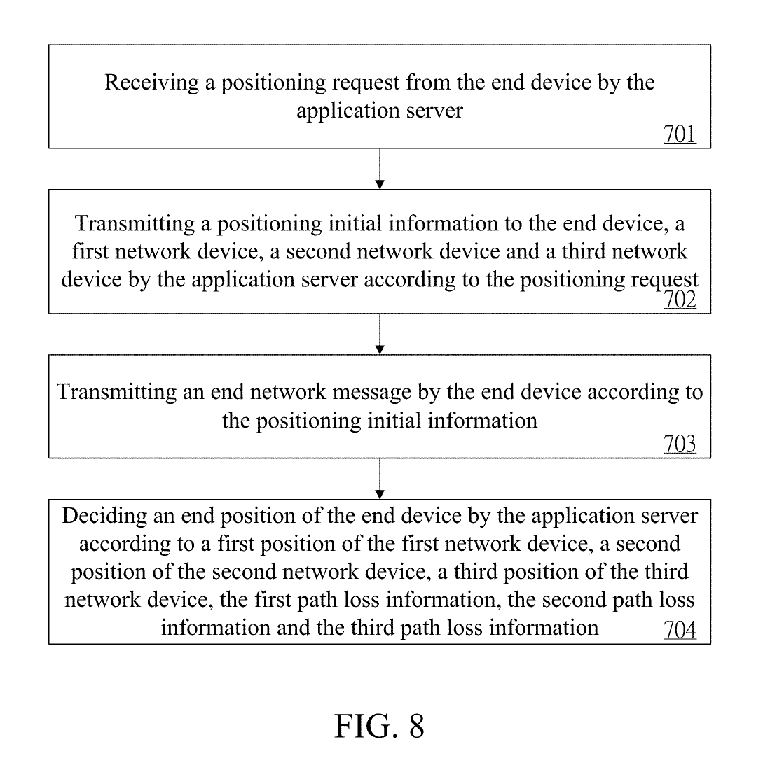

An eighth embodiment of the present invention is a positioning method, and a flowchart diagram thereof is as shown in FIG. 8. The method of the eighth embodiment is for use in an LPWAN system (e.g., the LPWAN system of the aforesaid embodiments). The LPWAN system comprises an application server and an end device. Detailed steps of the eighth embodiment are as follows.

First, step 701 is executed to receive a positioning request from the end device by the application server. Step 702 is executed to transmit a positioning initial information to the end device, a first network device, a second network device and a third network device by the application server according to the positioning request.

Step 703 is executed to transmit an end network message by the end device according to the positioning initial information. The first network device, the second network device and the third network device determine first path loss information, second path loss information and third path loss information between the first network device, the second network device and the third network device and the end device respectively according to the positioning initial information and the end network message and transmit the first path loss information, the second path loss information and the third path loss information to the application server.

Next, step 704 is executed to decide an end position of the end device by the application server according to a first position of the first network device, a second position of the second network device, a third position of the third network device, the first path loss information, the second path loss information and the third path loss information.

It shall be particularly appreciated that, in the eighth embodiment, the end network message is an uplink message transmitted to a gateway server. Each of the network devices is one of a mobile device and the gateway server.

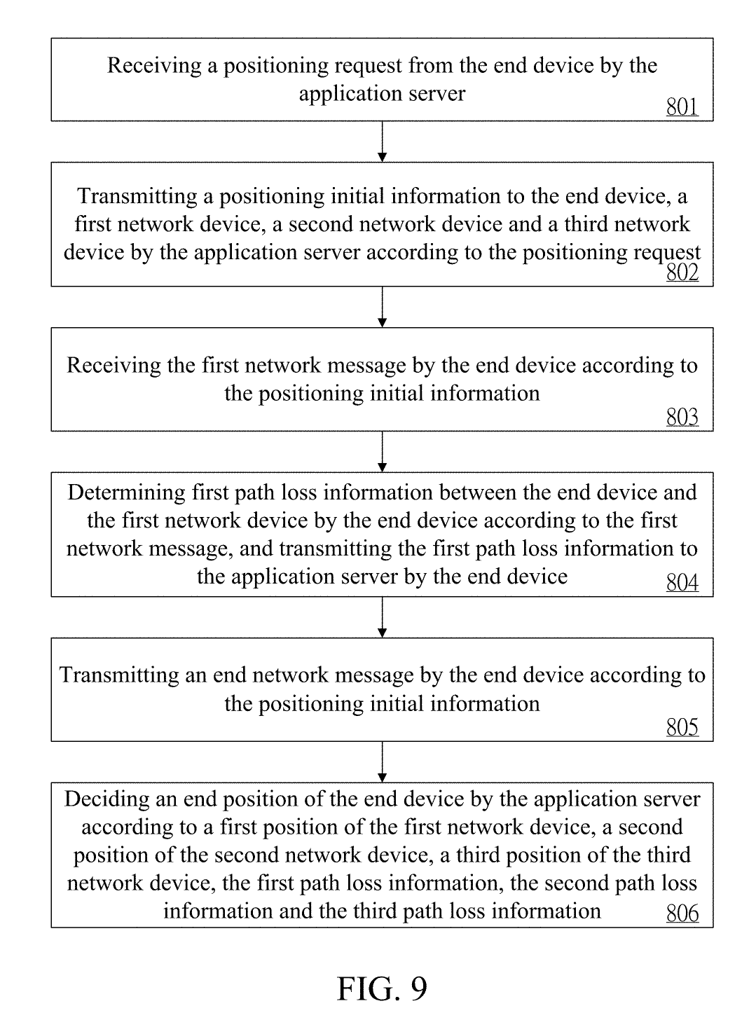

A ninth embodiment of the present invention is a positioning method, and a flowchart diagram thereof is as shown in FIG. 9. The method of the ninth embodiment is for use in an LPWAN system (e.g., the LPWAN system of the aforesaid embodiments). The LPWAN system comprises an application server and an end device. Detailed steps of the ninth embodiment are as follows.

First, step 801 is executed to receive a positioning request from the end device by the application server. Step 802 is executed to transmit a positioning initial information to the end device, a first network device, a second network device and a third network device by the application server according to the positioning request. The first network device transmits a first network message according to the positioning initial information. Step 803 is executed to receive the first network message by the end device according to the positioning initial information.

Step 804 is executed to determine first path loss information between the end device and the first network device by the end device according to the first network message, and transmit the first path loss information to the application server by the end device. Step 805 is executed to transmit an end network message by the end device according to the positioning initial information. The second network device and the third network device determine second path loss information and third path loss information between the second network device and the third network device and the end device respectively according to the end network message and the positioning initial information and transmit the second path loss information and the third path loss information to the application server.

Finally, step 806 is executed to decide an end position of the end device by the application server according to a first position of the first network device, a second position of the second network device, a third position of the third network device, the first path loss information, the second path loss information and the third path loss information.

It shall be particularly appreciated that, the positioning technology applied to the application server side of the present invention described above may also be directly applied to the mobile device or the gateway server. In this way, the positioning need of the mobile device can also be satisfied even under a local area network environment in which only the mobile device or the gateway server is comprised.

According to the above descriptions, the LPWAN system of the present invention mainly utilizes the application server to determine the position of the end device more accurately with the assistance of network devices according to the signal loss information of the network devices with respect to the end device. In this way, the positioning accuracy can be improved remarkably, and meanwhile the low-power requirements of the LPWAN can be satisfied so that the problems in the prior art are solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A low power wide area network (LPWAN) system, comprising:
an end device, comprising a device processor and a device transceiver;
an application server, comprising a server processor and a server transceiver, the server processor being configured to:
receive a positioning request from the end device via the server transceiver; and
transmit a positioning initial information to the end device and at least one network device via the server transceiver according to the positioning request so that the at least one network device transmits at least one network message according to the positioning initial information;
wherein the device processor of the end device is configured to:
receive the at least one network message via the device transceiver according to the positioning initial information;
determine at least one path loss information between the end device and the at least one network device according to the at least one network message;
transmit the at least one path loss information to the application server via the device transceiver;
wherein the server processor of the application server decides an end position of the end device according to at least one position of the at least one network device and the at least one path loss information.

2. The LPWAN system of claim 1, wherein the at least one network device comprises a first network device, a second network device and a third network device, and the server processor is further configured to:
transmit the positioning initial information to the end device, the first network device, the second network device and the third network device via the server transceiver according to the positioning request so that the first network device, the second network device and the third network device transmit a first network message, a second network message and a third network message respectively based on the positioning initial information;
wherein the device processor of the end device is further configured to:
receive the first network message, the second network message and the third network message via the device transceiver based on the positioning initial information;
determine a first path loss information, a second path loss information and a third path loss information between the end device and the first network device, the second network device and the third network device respectively according to the first network message, the second network message and the third network message;
transmit the first path loss information, the second path loss information and the third path loss information to the application server via the device transceiver;
wherein the server processor of the application server decides the end position of the end device according to a first position of the first network device, a second position of the second network device, a third position of the third network device, the first path loss information, the second path loss information and the third path loss information.

3. The LPWAN system of claim 2, wherein the first network device, the second network device or the third network device is one of a mobile device and a gateway server, and when the first network device, the second network device or the third network device is the mobile device, the first network message, the second network message or the third network message is an uplink message transmitted to the gateway server, and when the first network device, the second network device or the third network device is the gateway server, the first network message, the second network message or the third network message is a downlink message transmitted to the end device.

4. The LPWAN system of claim 1, wherein the at least one network device comprises a first network device, a second network device and a third network device, and the server processor is further configured to:
transmit the positioning initial information to the end device, the first network device, the second network device and the third network device via the server transceiver according to the positioning request so that the first network device and the second network device transmit a first network message and a second network message respectively based on the positioning initial information;
wherein the device processor of the end device is configured to:
receive the first network message and the second network message via the device transceiver based on the positioning initial information;
determine a first path loss information and a second path loss information between the end device and the first network device and the second network device respectively according to the first network message and the second network message, and transmit the first path loss information and the second path loss information to the application server via the device transceiver;
transmit an end network message to the third network device via the device transceiver based on the positioning initial information so that the third network device, based on the positioning initial information, determines a third path loss information between the third network device and the end device according to the end network message and transmits the third path loss information to the application server;
wherein the server processor of the application server decides the end position of the end device according to a first position of the first network device, a second position of the second network device, a third position of the third network device, the first path loss information, the second path loss information and the third path loss information.

5. The LPWAN system of claim 4, wherein the end network message is an uplink message transmitted to a gateway server, and the first network device, the second network device or the third network device is one of a mobile device and the gateway server, wherein:
when the first network device or the second network device is the mobile device, the first network message or the second network message is an uplink message transmitted to the gateway server; and
when the first network device or the second network device is the gateway server, the first network message or the second network message is a downlink message transmitted to the end device.

6. The LPWAN system of claim 1, wherein the at least one network device comprises a first network device, a second network device and a third network device, and the server processor is further configured to:
transmit the positioning initial information to the end device and the first network device via the server transceiver according to the positioning request so that the first network device transmits a first network message based on the positioning initial information;
wherein the device processor of the end device is further configured to:
receive the first network message via the device transceiver based on the positioning initial information;
determine a first path loss information between the end device and the first network device according to the first network message, and transmit the first path loss information to the application server via the device transceiver;
transmit an end network message to the second network device and the third network device via the device transceiver based on the positioning initial information so that the second network device and the third network device, based on the positioning initial information, determine a second path loss information and a third path loss information between the second network device and the third network device and the end device respectively according to the end network message and transmit the second path loss information and the third path loss information to the application server;
wherein the server processor of the application server decides the end position of the end device according to a first position of the first network device, a second position of the second network device, a third position of the third network device, the first path loss information, the second path loss information and the third path loss information.

7. The LPWAN system of claim 6, wherein the end network message is an uplink message transmitted to a gateway server, and the first network device, the second network device or the third network device is one of a mobile device and the gateway server, wherein:
when the first network device is the mobile device, the first network message is an uplink message transmitted to the gateway server; and
when the first network device is the gateway server, the first network message is a downlink message transmitted to the end device.

8. A low power wide area network (LPWAN) system, comprising:
an end device, comprising a device processor and a device transceiver;
an application server, comprising a server processor and a server transceiver, the server processor being configured to:
receive a positioning request from the end device via the server transceiver; and
transmit a positioning initial information to the end device, a first network device, a second network device and a third network device via the server transceiver according to the positioning request;
wherein the device processor of the end device is configured to:
transmit an end network message via the device transceiver based on the positioning initial information so that the first network device, the second network device and the third network device, based on the positioning initial information, determine a first path loss information, a second path loss information and a third path loss information between the first network device, the second network device and the third network device and the end device respectively according to the end network message and transmit the first path loss information, the second path loss information and the third path loss information to the application server respectively;
wherein the server processor of the application server is further configured to:
decide an end position of the end device according to a first position of the first network device, a second position of the second network device, a third position of the third network device, the first path loss information, the second path loss information and the third path loss information.

9. The LPWAN system of claim 8, wherein the end network message is an uplink message transmitted to a gateway server, and the first network device, the second network device or the third network device is one of a mobile device and the gateway server.
